(19) United States
(12) Patent Application Publication
(10) Pub. No.: US 2009/0179967 A1
(43) Pub. Date: Jul. 16, 2009

(54) MULTIPLE CONDUIT FLUID COUPLING WITH LEAKAGE FLOW CONTROL

(75) Inventors: Norman Michael Berry, Balmain (AU); Geoffrey Philip Dyer, Balmain (AU); Michael John Hudson, Balmain (AU); Akira Nakazawa, Balmain (AU); Garry Raymond Jackson, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 12/014,769

(22) Filed: Jan. 16, 2008

(51) Int. Cl. B41J 2/175

(52) U.S. Cl. 347/85

(57) ABSTRACT

A fluid coupling for an inkjet printhead, that has an interface plate supporting a plurality of spouts positioned for sealed engagement with corresponding apertures in a complementary socket in order to establish fluid communication between an inkjet printhead and an ink supply. The interface plate has surface formations individually associated with each of the spouts respectively. The surface formations define a preferred flow path along the interface plate for any residual ink draining away from the spouts under gravity. The preferred flow paths are configured to avoid any of the other spouts.

### FIELD OF THE INVENTION

The present invention relates to the field of fluid couplings and in particular, fluid couplings for supplying ink to inkjet printheads.

### CO-PENDING APPLICATIONS

The following applications have been filed by the Applicant simultaneously with the present application:

| | | | | | |
|---|---|---|---|---|---|
| RRE012US | RRE013US | RRE015US | RRE016US | RRE017US | RRE018US |
| RRE019US | RRE020US | RRE021US | RRE022US | RRE023US | RRE024US |
| RRE025US | RRE026US | RRE027US | RRE028US | RRE029US | RRE030US |
| RRE031US | RRE032US | RRE033US | RRE034US | RRE035US | RRE036US |
| RRE037US | RRE038US | RRE039US | RRE040US | RRE041US | RRE042US |
| RRE043US | RRE044US | RRE045US | RRE046US | | |

The disclosures of these co-pending applications are incorporated herein by reference. The above applications have been identified by their filing docket number, which will be substituted with the corresponding application number, once assigned.

### CROSS REFERENCES

The following patents or patent applications filed by the applicant or assignee of the present invention are hereby incorporated by cross-reference.

| | | | | | | |
|---|---|---|---|---|---|---|
| 6276850 | 6520631 | 6158907 | 6539180 | 6270177 | 6405055 | 6628430 |
| 6835135 | 6626529 | 6981769 | 7125338 | 7125337 | 7136186 | 7286260 |
| 7145689 | 7130075 | 7081974 | 7177055 | 7209257 | 6443555 | 7161715 |
| 7154632 | 7158258 | 7148993 | 7075684 | 10/943905 | 10/943906 | 10/943904 |
| 10/943903 | 10/943902 | 6966659 | 6988841 | 7077748 | 7255646 | 7070270 |
| 7014307 | 7158809 | 7217048 | 11/225172 | 11/255942 | 11/329039 | 11/329040 |
| 7271829 | 11/442189 | 11/474280 | 11/483061 | 11/503078 | 11/520735 | 11/505858 |
| 11/525850 | 11/583870 | 11/592983 | 11/592208 | 11/601828 | 11/635482 | 11/635526 |
| 10/466440 | 7215441 | 11/650545 | 11/653241 | 11/653240 | 7056040 | 6942334 |
| 11/706300 | 11/740265 | 11/737720 | 11/739056 | 11/740204 | 11/740223 | 11/753557 |
| 11/750285 | 11758648 | 11/778559 | 11834634 | 11/838878 | 11845669 | 6799853 |
| 7237896 | 6749301 | 10/451722 | 7137678 | 7252379 | 7144107 | 10/503900 |
| 10/503898 | 10/503897 | 7220068 | 7270410 | 7241005 | 7108437 | 7140792 |
| 10/503922 | 7224274 | 10/503917 | 10/503918 | 10/503925 | 10/503927 | 10/503928 |
| 10/503929 | 10/503885 | 7195325 | 7229164 | 7150523 | 10/503889 | 7154580 |
| 6906778 | 7167158 | 7128269 | 6688528 | 6986613 | 6641315 | 7278702 |
| 10/503891 | 7150524 | 7155395 | 6915140 | 6999206 | 6795651 | 6883910 |
| 7118481 | 7136198 | 7092130 | 6786661 | 6808325 | 10/920368 | 10/920284 |
| 7219990 | 10/920283 | 6750901 | 6476863 | 6788336 | 6322181 | 6597817 |
| 6227648 | 6727948 | 6690419 | 10/470947 | 6619654 | 6969145 | 6679582 |
| 10/470942 | 6568670 | 6866373 | 7280247 | 7008044 | 6742871 | 6966628 |
| 6644781 | 6969143 | 6767076 | 6834933 | 6692113 | 6913344 | 6727951 |
| 7128395 | 7036911 | 7032995 | 6969151 | 6955424 | 6969162 | 10/919249 |
| 6942315 | 11/006577 | 7234797 | 6986563 | 7295211 | 11/045442 | 7286162 |
| 7283159 | 7077330 | 6196541 | 11/149389 | 11/185725 | 7226144 | 11/202344 |
| 7267428 | 11/248423 | 11/248422 | 7093929 | 11/282769 | 11/330060 | 11/442111 |
| 7290862 | 11/499806 | 11/499710 | 6195150 | 11749156 | 11782588 | 11/854435 |
| 11/853817 | 11/935958 | 11924608 | 6362868 | 6831681 | 6431669 | 6362869 |
| 6472052 | 6356715 | 6894694 | 6636216 | 6366693 | 6329990 | 6459495 |
| 6137500 | 6690416 | 7050143 | 6398328 | 7110024 | 6431704 | 6879341 |
| 6415054 | 6665454 | 6542645 | 6486886 | 6381361 | 6317192 | 6850274 |
| 09/113054 | 6646757 | 6624848 | 6357135 | 6271931 | 6353772 | 6106147 |
| 6665008 | 6304291 | 6305770 | 6289262 | 6315200 | 6217165 | 6496654 |
| 6859225 | 6924835 | 6647369 | 6943830 | 09/693317 | 7021745 | 6712453 |
| 6460971 | 6428147 | 6416170 | 6402300 | 6464340 | 6612687 | 6412912 |
| 6447099 | 6837567 | 6505913 | 7128845 | 6733684 | 7249108 | 6566858 |
| 6331946 | 6246970 | 6442525 | 09/517384 | 09/505951 | 6374354 | 7246098 |
| 6816968 | 6757832 | 6334190 | 6745331 | 7249109 | 10/203559 | 7197642 |
| 7093139 | 10/636263 | 10/636283 | 10/866608 | 7210038 | 10/902883 | 10/940653 |
| 10/942858 | 11/706329 | 11/757385 | 11/758642 | 7119836 | 7283162 | 7286169 |
| 10/636285 | 7170652 | 6967750 | 6995876 | 7099051 | 7172191 | 7243916 |
| 7222845 | 11/239232 | 7285227 | 7063940 | 11/107942 | 7193734 | 7086724 |
| 7090337 | 7278723 | 7140717 | 11/190902 | 11/209711 | 7256824 | 7140726 |
| 7156512 | 7186499 | 11/478585 | 11/525862 | 11/540574 | 11/583875 | 11/592181 |
| 6750944 | 11/599336 | 7291447 | 11744183 | 11/758646 | 11/778561 | 11/839532 |
| 11/838874 | 11/853021 | 11/869710 | 11/868531 | 11927403 | 10/636225 | 6985207 |
| 6773874 | 6650836 | 10/666495 | 10/636224 | 7250975 | 7295343 | 6880929 |
| 7236188 | 7236187 | 7155394 | 10/636219 | 10/636223 | 7055927 | 6986562 |
| 7052103 | 10/656469 | 10/656281 | 10/656791 | 10/666124 | 10/683217 | 7289142 |
| 7095533 | 6914686 | 6896252 | 6820871 | 6834851 | 6848686 | 6830246 |
| 6851671 | 10/729098 | 7092011 | 7187404 | 10/729159 | 10/753458 | 6878299 |
| 6929348 | 6921154 | 10/780625 | 10/804042 | 6913346 | 10/831238 | 10/831237 |
| 10/831239 | 10/831240 | 10/831241 | 10/831234 | 10/831233 | 7246897 | 7077515 |
| 10/831235 | 10/853336 | 10/853117 | 10/853659 | 10/853681 | 6913875 | 7021758 |
| 7033017 | 7161709 | 7099033 | 7147294 | 7156494 | 11/012024 | 11/011925 |
| 7032998 | 7044585 | 7296867 | 6994424 | 11/006787 | 7258435 | 7097263 |
| 7001012 | 7004568 | 7040738 | 7188933 | 7027080 | 7025446 | 6991321 |
| 7131715 | 7261392 | 7207647 | 7182435 | 7097285 | 11/228410 | 7097284 |
| 7083264 | 7147304 | 7232203 | 7156498 | 7201471 | 11/501772 | 11/503084 |
| 11/513073 | 7210764 | 11/635524 | 11/706379 | 11/730386 | 11/730784 | 11/753568 |
| 11/782591 | 11/859783 | 6710457 | 6775906 | 6507099 | 7221043 | 7107674 |
| 7154172 | 11/442400 | 7247941 | 11/736540 | 11/758644 | 11/940304 | 6530339 |
| 6631897 | 6851667 | 6830243 | 6860479 | 6997452 | 7000913 | 7204482 |
| 11/212759 | 11/281679 | 11/730409 | 6238044 | 6425661 | 11/003786 | 7258417 |
| 7293853 | 11/003334 | 7270395 | 11/003404 | 11/003419 | 11/003700 | 7255419 |
| 7284819 | 7229148 | 7258416 | 7273263 | 7270393 | 6984017 | 11/003699 |
| 11/071473 | 7156497 | 11/601670 | 11748482 | 11/778563 | 11/779851 | 11/778574 |
| 11/853816 | 11/853814 | 11/853786 | 11/872037 | 11/856694 | 11/003463 | 11/003701 |
| 11/003683 | 11/003614 | 7284820 | 11/003684 | 7246875 | 11/003617 | 11/764760 |
| 11853777 | 11/293800 | 11/293802 | 11/293801 | 11/293808 | 11/293809 | 11/482975 |
| 11/482970 | 11/482968 | 11/482972 | 11/482971 | 11/482969 | 6431777 | 6334664 |
| 6447113 | 7239407 | 6398359 | 6652089 | 6652090 | 7057759 | 6631986 |
| 7187470 | 7280235 | 11/501775 | 11744210 | 11/859784 | 6471331 | 6676250 |
| 6347864 | 6439704 | 6425700 | 6588952 | 6626515 | 6722758 | 6871937 |
| 11/060803 | 11/097266 | 11/097267 | 11/685084 | 11/685086 | 11/685090 | 11/740925 |
| 11/763444 | 11/763443 | 11946840 | 7249942 | 7206654 | 7162324 | 7162325 |
| 7231275 | 7146236 | 7278847 | 10/753499 | 6997698 | 7220112 | 7231276 |
| 10/753440 | 7220115 | 7195475 | 7144242 | 11/499746 | 11/501774 | 11/525858 |
| 11/545501 | 11/599335 | 11/706380 | 11736545 | 11/736554 | 11/739047 | 11749159 |
| 11/739073 | 11/775160 | 11/853755 | 11/940291 | 11934071 | 6786420 | 6827282 |
| 6948661 | 7073713 | 10/983060 | 7093762 | 7083108 | 7222799 | 7201319 |
| 11/442103 | 11/739071 | 11/518238 | 11/518280 | 11/518244 | 11/518243 | 11/518242 |
| 7032899 | 6854724 | 11/084237 | 11/084240 | 11/084238 | 11/357296 | 11/357298 |
| 11/357297 | 6350023 | 6318849 | 6592207 | 6439699 | 6312114 | 11/246676 |
| 11/246677 | 11/246678 | 11/246679 | 11/246680 | 11/246681 | 11/246714 | 11/246713 |
| 11/246689 | 11/246671 | 11/246670 | 11/246669 | 11/246704 | 11/246710 | 11/246688 |
| 11/246716 | 11/246715 | 11/246707 | 11/246706 | 11/246705 | 11/246708 | 11/246693 |
| 11/246692 | 11/246696 | 11/246695 | 11/246694 | 11/482958 | 11/482955 | 11/482962 |
| 11/482963 | 11/482956 | 11/482954 | 11/482974 | 11/482957 | 11/482987 | 11/482959 |
| 11/482960 | 11/482961 | 11/482964 | 11/482965 | 11/482976 | 11/482973 | 11/495815 |
| 11/495816 | 11/495817 | 10/803074 | 10/803073 | 7040823 | 10/803076 | 10/803077 |
| 10/803078 | 10/803079 | 10/922971 | 10/922970 | 10/922836 | 10/922842 | 10/922848 |
| 10/922843 | 7125185 | 7229226 | 11/513386 | 11/753559 | 10/815621 | 7243835 |
| 10/815630 | 10/815637 | 10/815638 | 7251050 | 10/815642 | 7097094 | 7137549 |
| 10/815618 | 7156292 | 11738974 | 10/815635 | 10/815647 | 10/815634 | 7137566 |
| 7131596 | 7128265 | 7207485 | 7197374 | 7175089 | 10/815617 | 10/815620 |
| 7178719 | 10/815613 | 7207483 | 7296737 | 7270266 | 10/815614 | 11/446240 |
| 11/488162 | 11/488163 | 11/488164 | 11/488167 | 11/488168 | 11/488165 | 11/488166 |
| 7267273 | 11/834628 | 11/839497 | 11/944449 | 10/815636 | 7128270 | 11/041650 |
| 11/041651 | 11/041652 | 11/041649 | 11/041610 | 11863253 | 11863255 | 11/863257 |
| 11863258 | 11863262 | 11/041609 | 11/041626 | 11/041627 | 11/041624 | 11/041625 |
| 11863268 | 11863269 | 11863270 | 11863271 | 11863273 | 76584733 | 11/041556 |
| 11/041580 | 11/041723 | 11/041698 | 11/041648 | 11863263 | 11863264 | 11863265 |
| 11863266 | 11863267 | 10/815609 | 7150398 | 7159777 | 10/815610 | 7188769 |
| 7097106 | 7070110 | 7243849 | 11/442381 | 11/480957 | 11/764694 | 6227652 |
| 6213588 | 6213589 | 6231163 | 6247795 | 6394581 | 6244691 | 6257704 |
| 6416168 | 6220694 | 6257705 | 6247794 | 6234610 | 6247793 | 6264306 |
| 6241342 | 6247792 | 6264307 | 6254220 | 6234611 | 6302528 | 6283582 |
| 6239821 | 6338547 | 6247796 | 6557977 | 6390603 | 6362843 | 6293653 |
| 6312107 | 6227653 | 6234609 | 6238040 | 6188415 | 6227654 | 6209989 |
| 6247791 | 6336710 | 6217153 | 6416167 | 6243113 | 6283581 | 6247790 |
| 6260953 | 6267469 | 6588882 | 6742873 | 6918655 | 6547371 | 6938989 |
| 6598964 | 6923526 | 6273544 | 6309048 | 6420196 | 6443558 | 6439689 |
| 6378989 | 6848181 | 6634735 | 6299289 | 6299290 | 6425654 | 6902255 |
| 6623101 | 6406129 | 6505916 | 6457809 | 6550895 | 6457812 | 7152962 |
| 6428133 | 7216956 | 7080895 | 11/144844 | 7182437 | 11/599341 | 11/635533 |
| 11/607976 | 11/607975 | 11/607999 | 11/607980 | 11/607979 | 11/607978 | 11/735961 |
| 11/685074 | 11/696126 | 11/696144 | 11/696650 | 11/763446 | 6224780 | 6235212 |
| 6280643 | 6284147 | 6214244 | 6071750 | 6267905 | 6251298 | 6258285 |
| 6225138 | 6241904 | 6299786 | 6866789 | 6231773 | 6190931 | 6248249 |
| 6290862 | 6241906 | 6565762 | 6241905 | 6451216 | 6231772 | 6274056 |
| 6290861 | 6248248 | 6306671 | 6331258 | 6110754 | 6294101 | 6416679 |
| 6264849 | 6254793 | 6245246 | 6855264 | 6235211 | 6491833 | 6264850 |
| 6258284 | 6312615 | 6228668 | 6180427 | 6171875 | 6267904 | 6245247 |
| 6315914 | 7169316 | 6526658 | 7210767 | 11/056146 | 11/635523 | 6665094 |
| 6450605 | 6512596 | 6654144 | 7125090 | 6687022 | 7072076 | 7092125 |
| 7215443 | 7136195 | 7077494 | 6877834 | 6969139 | 10/636227 | 7283280 |
| 6912067 | 7277205 | 7154637 | 10/636230 | 7070251 | 6851782 | 10/636211 |
| 10/636247 | 6843545 | 7079286 | 7064867 | 7065247 | 7027177 | 7218415 |
| 7064873 | 6954276 | 7061644 | 7092127 | 7059695 | 10/990382 | 7177052 |
| 7270394 | 11/124231 | 7188921 | 7187469 | 7196820 | 11/281445 | 7283281 |
| 7251051 | 7245399 | 11/524911 | 11/640267 | 11/706297 | 11/730387 | 11/737142 |
| 11/764729 | 11/834637 | 11/853019 | 11/863239 | 11/305274 | 11/305273 | 11/305275 |
| 11/305152 | 11/305158 | 11/305008 | 6231148 | 6293658 | 6614560 | 6238033 |
| 6312070 | 6238111 | 6378970 | 6196739 | 6270182 | 6152619 | 7006143 |
| 6876394 | 6738096 | 6970186 | 6287028 | 6412993 | 11/033145 | 11/102845 |
| 11/102861 | 11/248421 | 11/672878 | 7204941 | 7282164 | 10/815628 | 11845672 |
| 7278727 | 10/913373 | 10/913374 | 10/913372 | 7138391 | 7153956 | 10/913380 |
| 10/913379 | 10/913376 | 7122076 | 7148345 | 11/172816 | 11/172815 | 11/172814 |
| 11/482990 | 11/482986 | 11/482985 | 11/454899 | 11/583942 | 11/592990 | 11849360 |
| 11/831961 | 11/831962 | 11/831963 | 60951700 | 11/832629 | 11/832637 | 60971535 |
| 10/407212 | 7252366 | 10/683064 | 10/683041 | 7275811 | 10/884889 | 10/922890 |
| 10/922875 | 10/922885 | 10/922889 | 10/922884 | 10/922879 | 10/922887 | 10/922888 |
| 10/922874 | 7234795 | 10/922871 | 10/922880 | 7293855 | 10/922882 | 10/922883 |
| 10/922878 | 10/922872 | 10/922876 | 10/922886 | 10/922877 | 7147792 | 7175774 |
| 11/159193 | 11/491378 | 11766713 | 11/841647 | 11/482980 | 11/563684 | 11/482967 |
| 11/482966 | 11/482988 | 11/482989 | 11/293832 | 11/293838 | 11/293825 | 11/293841 |
| 11/293799 | 11/293796 | 11/293797 | 11/293798 | 11/124158 | 11/124196 | 11/124199 |
| 11/124162 | 11/124202 | 11/124197 | 11/124154 | 11/124198 | 7284921 | 11/124151 |
| 11/124160 | 11/124192 | 11/124175 | 11/124163 | 11/124149 | 11/124152 | 11/124173 |
| 11/124155 | 7236271 | 11/124174 | 11/124194 | 11/124164 | 11/124200 | 11/124195 |
| 11/124166 | 11/124150 | 11/124172 | 11/124165 | 11/124186 | 11/124185 | 11/124184 |
| 11/124182 | 11/124201 | 11/124171 | 11/124181 | 11/124161 | 11/124156 | 11/124191 |
| 11/124159 | 11/124176 | 11/124188 | 11/124170 | 11/124187 | 11/124189 | 11/124190 |
| 11/124180 | 11/124193 | 11/124183 | 11/124178 | 11/124177 | 11/124148 | 11/124168 |
| 11/124167 | 11/124179 | 11/124169 | 11/187976 | 11/188011 | 11/188014 | 11/482979 |
| 11/735490 | 11/853018 | 11/944450 | 11/228540 | 11/228500 | 11/228501 | 11/228530 |
| 11/228490 | 11/228531 | 11/228504 | 11/228533 | 11/228502 | 11/228507 | 11/228482 |
| 11/228505 | 11/228497 | 11/228487 | 11/228529 | 11/228484 | 11/228489 | 11/228518 |
| 11/228536 | 11/228496 | 11/228488 | 11/228506 | 11/228516 | 11/228526 | 11/228539 |
| 11/228538 | 11/228524 | 11/228523 | 11/228519 | 11/228528 | 11/228527 | 11/228525 |
| 11/228520 | 11/228498 | 11/228511 | 11/228522 | 11/228515 | 11/228537 | 11/228534 |
| 11/228491 | 11/228499 | 11/228509 | 11/228492 | 11/228493 | 11/228510 | 11/228508 |
| 11/228512 | 11/228514 | 11/228494 | 11/228495 | 11/228486 | 11/228481 | 11/228477 |
| 11/228485 | 11/228483 | 11/228521 | 11/228517 | 11/228532 | 11/228513 | 11/228503 |
| 11/228480 | 11/228535 | 11/228478 | 11/228479 | 6238115 | 6386535 | 6398344 |
| 6612240 | 6752549 | 6805049 | 6971313 | 6899480 | 6860664 | 6925935 |
| 6966636 | 7024995 | 7284852 | 6926455 | 7056038 | 6869172 | 7021843 |
| 6988845 | 6964533 | 6981809 | 7284822 | 7258067 | 11/155544 | 7222941 |
| 7284925 | 7278795 | 7249904 | 11/737726 | 11772240 | 11/863246 | 11/863145 |
| 11/865650 | 6087638 | 6340222 | 6041600 | 6299300 | 6067797 | 6286935 |
| 6044646 | 6382769 | 10/868866 | 6787051 | 6938990 | 11/242916 | 11/242917 |
| 11/144799 | 11/198235 | 11861282 | 11861284 | 11/766052 | 7152972 | 11/592996 |
| D529952 | 6390605 | 6322195 | 6612110 | 6480089 | 6460778 | 6305788 |
| 6426014 | 6364453 | 6457795 | 6315399 | 6338548 | 7040736 | 6938992 |
| 6994425 | 6863379 | 6540319 | 6994421 | 6984019 | 7008043 | 6997544 |
| 6328431 | 6991310 | 10/965772 | 7140723 | 6328425 | 6982184 | 7267423 |
| 7134741 | 7066577 | 7152945 | 11/038200 | 7021744 | 6991320 | 7155911 |
| 11/107799 | 6595624 | 7152943 | 7125103 | 11/209709 | 7290857 | 7285437 |
| 7229151 | 11/330058 | 7237873 | 11/329163 | 11/442180 | 11/450431 | 7213907 |
| 6417757 | 11/482951 | 11/545566 | 11/583826 | 11/604315 | 11/604323 | 11/643845 |
| 11/706950 | 11/730399 | 11749121 | 11/753549 | 11/834630 | 11/935389 | 019936/0467 |
| 7095309 | 11/945157 | 6854825 | 6623106 | 6672707 | 6575561 | 6817700 |
| 6588885 | 7075677 | 6428139 | 6575549 | 6846692 | 6425971 | 7063993 |
| 6383833 | 6955414 | 6412908 | 6746105 | 6953236 | 6412904 | 7128388 |
| 6398343 | 6652071 | 6793323 | 6659590 | 6676245 | 7201460 | 6464332 |
| 6659593 | 6478406 | 6978613 | 6439693 | 6502306 | 6966111 | 6863369 |
| 6428142 | 6874868 | 6390591 | 6799828 | 6896358 | 7018016 | 10/296534 |
| 6328417 | 6322194 | 6382779 | 6629745 | 6565193 | 6609786 | 6609787 |
| 6439908 | 6684503 | 6843551 | 6764166 | 6561617 | 10/510092 | 6557970 |
| 6546628 | 10/510098 | 6652074 | 6820968 | 7175260 | 6682174 | 10/510207 |
| 6648453 | 6834932 | 6682176 | 6998062 | 6767077 | 7278717 | 6755509 |
| 10/534813 | 6692108 | 10/534811 | 6672709 | 10/534823 | 7086718 | 10/534881 |
| 6672710 | 10/534812 | 6669334 | 10/534804 | 7152958 | 7281782 | 6824246 |
| 7264336 | 6669333 | 10/534815 | 6820967 | 10/534883 | 6736489 | 7264335 |
| 6719406 | 7222943 | 7188419 | 7168166 | 6974209 | 7086719 | 6974210 |
| 7195338 | 7252775 | 7101025 | 11/474281 | 11/485258 | 11/706304 | 11/706324 |
| 11/706326 | 11/706321 | 11/772239 | 11/782598 | 11/829941 | 019804/0802 | 11852986 |
| 11/936062 | 11/934027 | 11/763440 | 11/763442 | 11/246687 | 11/246718 | 11/246685 |
| 11/246686 | 11/246703 | 11/246691 | 11/246711 | 11/246690 | 11/246712 | 11/246717 |
| 11/246709 | 11/246700 | 11/246701 | 11/246702 | 11/246668 | 11/246697 | 11/246698 |
| 11/246699 | 11/246675 | 11/246674 | 11/246667 | 11/829957 | 11/829960 | 11/829961 |
| 11/829962 | 11/829963 | 11/829966 | 11/829967 | 11/829968 | 11/829969 | 11946839 |
| 11946838 | 11946837 | 7156508 | 7159972 | 7083271 | 7165834 | 7080894 |
| 7201469 | 7090336 | 7156489 | 10/760233 | 10/760246 | 7083257 | 7258422 |
| 7255423 | 7219980 | 10/760253 | 10/760255 | 10/760209 | 7118192 | 10/760194 |
| 10/760238 | 7077505 | 7198354 | 7077504 | 10/760189 | 7198355 | 10/760232 |
| 10/760231 | 7152959 | 7213906 | 7178901 | 7222938 | 7108353 | 7104629 |
| 11/446227 | 11/454904 | 11/472345 | 11/474273 | 7261401 | 11/474279 | 11/482939 |
| 11/482950 | 11/499709 | 11/592984 | 11/601668 | 11/603824 | 11/601756 | 11/601672 |
| 11/650546 | 11/653253 | 11/706328 | 11/706299 | 11/706965 | 11/737080 | 11/737041 |
| 11/778062 | 11/778566 | 11/782593 | 11/934018 | 11/945157 | 11/246684 | 11/246672 |
| 11/246673 | 11/246683 | 11/246682 | 60/939086 | 11860538 | 11860539 | 11/860540 |
| 11860541 | 11860542 | 11/936060 | 11877667 | 11877668 | 7246886 | 7128400 |
| 7108355 | 6991322 | 7287836 | 7118197 | 10/728784 | 10/728783 | 7077493 |
| 6962402 | 10/728803 | 7147308 | 10/728779 | 7118198 | 7168790 | 7172270 |
| 7229155 | 6830318 | 7195342 | 7175261 | 10/773183 | 7108356 | 7118202 |
| 10/773186 | 7134744 | 10/773185 | 7134743 | 7182439 | 7210768 | 10/773187 |
| 7134745 | 7156484 | 7118201 | 7111926 | 10/773184 | 7018021 | 11/060751 |
| 11/060805 | 11/188017 | 7128402 | 11/298774 | 11/329157 | 11/490041 | 11/501767 |
| 7284839 | 7246885 | 7229156 | 11/505846 | 11/505857 | 7293858 | 11/524908 |
| 11/524938 | 7258427 | 11/524912 | 7278716 | 11/592995 | 11/603825 | 11/649773 |
| 11/650549 | 11/653237 | 11/706378 | 11/706962 | 11749118 | 11/754937 | 11749120 |
| 11/744885 | 11/779850 | 11/765439 | 11/842950 | 11/839539 | 11/926121 | 11/097308 |
| 11/097309 | 7246876 | 11/097299 | 11/097310 | 11/097213 | 11/210687 | 11/097212 |
| 7147306 | 7261394 | 11/764806 | 11/782595 | 11/482953 | 11/482977 | 11/544778 |
| 11/544779 | 11/764808 | 11/756624 | 11/756625 | 11/756626 | 11/756627 | 11/756628 |
| 11/756629 | 11/756630 | 11/756631 | 7156289 | 7178718 | 7225979 | 11/712434 |
| 11/084796 | 11/084742 | 11/084806 | 09/575197 | 09/575197 | 7079712 | 7079712 |
| 6825945 | 6825945 | 09/575165 | 09/575165 | 6813039 | 6813039 | 7190474 |
| 6987506 | 6987506 | 6824044 | 7038797 | 7038797 | 6980318 | 6980318 |
| 6816274 | 6816274 | 7102772 | 7102772 | 09/575186 | 09/575186 | 6681045 |
| 6681045 | 6678499 | 6679420 | 6963845 | 6976220 | 6728000 | 6728000 |
| 7110126 | 7173722 | 7173722 | 6976035 | 6813558 | 6766942 | 6965454 |
| 6995859 | 7088459 | 7088459 | 6720985 | 7286113 | 6922779 | 6978019 |
| 6847883 | 7131058 | 7295839 | 09/607843 | 09/693690 | 6959298 | 6973450 |
| 7150404 | 6965882 | 7233924 | 09/575181 | 09/575181 | 09/722174 | 7175079 |
| 7162259 | 6718061 | 10/291523 | 10/291471 | 7012710 | 6825956 | 10/291481 |
| 7222098 | 10/291825 | 7263508 | 7031010 | 6972864 | 6862105 | 7009738 |
| 6989911 | 6982807 | 10/291576 | 6829387 | 6714678 | 6644545 | 6609653 |
| 6651879 | 10/291555 | 7293240 | 10/291592 | 10/291542 | 7044363 | 7004390 |
| 6867880 | 7034953 | 6987581 | 7216224 | 10/291821 | 7162269 | 7162222 |
| 7290210 | 7293233 | 7293234 | 6850931 | 6865570 | 6847961 | 10/685523 |
| 10/685583 | 7162442 | 10/685584 | 7159784 | 10/804034 | 10/793933 | 6889896 |
| 10/831232 | 7174056 | 6996274 | 7162088 | 10/943874 | 10/943872 | 10/944044 |
| 7259884 | 10/944043 | 7167270 | 10/943877 | 6986459 | 10/954170 | 7181448 |
| 10/981626 | 10/981616 | 10/981627 | 7231293 | 7174329 | 10/992713 | 7295922 |
| 7200591 | 11/020106 | 11/020260 | 11/020321 | 11/020319 | 11/026045 | 11/059696 |
| 11/051032 | 11/059674 | 11/107944 | 11/107941 | 11/082940 | 11/082815 | 11/082827 |
| 11/082829 | 6991153 | 6991154 | 11/124256 | 11/123136 | 11/154676 | 11/159196 |
| 11/182002 | 11/202251 | 11/202252 | 11/202253 | 11/203200 | 11/202218 | 11/206778 |
| 11/203424 | 11/222977 | 11/228450 | 11/227239 | 11/286334 | 7225402 | 11/329187 |
| 11/349143 | 11/491225 | 11/491121 | 11/442428 | 11/454902 | 11/442385 | 11/478590 |
| 7271931 | 11/520170 | 11/603057 | 11/706964 | 11/739032 | 11739014 | 11/834633 |
| 11/830848 | 11/830849 | 11/839542 | 11/866394 | 11/934077 | 7068382 | 7068382 |
| 7007851 | 6957921 | 6457883 | 10/743671 | 7044381 | 11/203205 | 7094910 |
| 7091344 | 7122685 | 7038066 | 7099019 | 7062651 | 7062651 | 6789194 |
| 6789194 | 6789191 | 6789191 | 10/900129 | 7278018 | 10/913350 | 10/982975 |
| 10/983029 | 11/331109 | 6644642 | 6644642 | 6502614 | 6502614 | 6622999 |
| 6622999 | 6669385 | 6669385 | 6827116 | 7011128 | 10/949307 | 6549935 |
| 6549935 | 6987573 | 6987573 | 6727996 | 6727996 | 6591884 | 6591884 |
| 6439706 | 6439706 | 6760119 | 6760119 | 7295332 | 7295332 | 7064851 |
| 6826547 | 6290349 | 6290349 | 6428155 | 6428155 | 6785016 | 6785016 |
| 6831682 | 6741871 | 6927871 | 6980306 | 6965439 | 6840606 | 7036918 |
| 6977746 | 6970264 | 7068389 | 7093991 | 7190491 | 10/901154 | 10/932044 |
| 10/962412 | 7177054 | 10/962552 | 10/965733 | 10/965933 | 10/974742 | 10/982974 |
| 7180609 | 10/986375 | 11/107817 | 7292363 | 11/149160 | 11/206756 | 11/250465 |
| 7202959 | 11/653219 | 11/706309 | 11/730389 | 11/730392 | 60/953443 | 11/866387 |
| 60974077 | 6982798 | 6870966 | 6870966 | 6822639 | 6822639 | 6474888 |
| 6627870 | 6724374 | 6788982 | 7263270 | 6788293 | 6946672 | 6737591 |
| 6737591 | 7091960 | 09/693514 | 6792165 | 7105753 | 6795593 | 6980704 |
| 6768821 | 7132612 | 7041916 | 6797895 | 7015901 | 7289882 | 7148644 |
| 10/778056 | 10/778058 | 10/778060 | 10/778059 | 10/778063 | 10/778062 | 10/778061 |
| 10/778057 | 7096199 | 7286887 | 10/917467 | 10/917466 | 10/917465 | 7218978 |
| 7245294 | 7277085 | 7187370 | 10/917436 | 10/943856 | 10/919379 | 7019319 |
| 10/943878 | 10/943849 | 7043096 | 7148499 | 11/144840 | 11/155556 | 11/155557 |
| 11/193481 | 11/193435 | 11/193482 | 11/193479 | 11/255941 | 11/281671 | 11/298474 |
| 7245760 | 11/488832 | 11/495814 | 11/495823 | 11/495822 | 11/495821 | 11/495820 |
| 11/653242 | 11/754370 | 60911260 | 11/829936 | 11/839494 | 11866305 | 11866313 |
| 11866324 | 11866336 | 11866348 | 11866359 | 7055739 | 7055739 | 7233320 |
| 7233320 | 6830196 | 6830196 | 6832717 | 6832717 | 7182247 | 7120853 |
| 7082562 | 6843420 | 10/291718 | 6789731 | 7057608 | 6766944 | 6766945 |
| 7289103 | 10/291559 | 10/291660 | 7264173 | 10/409864 | 7108192 | 10/537159 |
| 7111791 | 7077333 | 6983878 | 10/786631 | 7134598 | 10/893372 | 6929186 |
| 6994264 | 7017826 | 7014123 | 7134601 | 7150396 | 10/971146 | 7017823 |
| 7025276 | 7284701 | 7080780 | 11/074802 | 11/442366 | 11749158 | 11/842948 |
| 10/492169 | 10/492152 | 10/492168 | 10/492161 | 10/492154 | 10/502575 | 10/531229 |
| 10/683151 | 10/531733 | 10/683040 | 10/510391 | 10/510392 | 10/778090 | 11/944404 |
| 11/936638 | 6957768 | 6957768 | 09/575172 | 09/575172 | 7170499 | 7170499 |
| 7106888 | 7106888 | 7123239 | 7123239 | 6982701 | 6982703 | 7227527 |
| 6786397 | 6947027 | 6975299 | 7139431 | 7048178 | 7118025 | 6839053 |
| 7015900 | 7010147 | 7133557 | 6914593 | 10/291546 | 6938826 | 7278566 |
| 7123245 | 6992662 | 7190346 | 11/074800 | 11/074782 | 11/074777 | 11/075917 |
| 7221781 | 11/102843 | 7213756 | 11/188016 | 7180507 | 7263225 | 7287688 |
| 11/737094 | 11/753570 | 11/782596 | 11/865711 | 11856061 | 11856062 | 11856064 |
| 11856066 | 11/672522 | 11/672950 | 11/672947 | 11/672891 | 11/672954 | 11/672533 |
| 11754310 | 11/754321 | 11/754320 | 11/754319 | 11/754318 | 11/754317 | 11/754316 |
| 11/754315 | 11/754314 | 11/754313 | 11/754312 | 11/754311 | 6593166 | 7132679 |
| 6940088 | 7119357 | 11/513077 | 6755513 | 6974204 | 6409323 | 7055930 |
| 6281912 | 6893109 | 6604810 | 6824242 | 6318920 | 7210867 | 6488422 |
| 6655786 | 6457810 | 6485135 | 6796731 | 6904678 | 6641253 | 7125106 |
| 6786658 | 7097273 | 6824245 | 7222947 | 6918649 | 6860581 | 6929351 |
| 7063404 | 6969150 | 7004652 | 6871938 | 6905194 | 6846059 | 6997626 |
| 10/974881 | 7029098 | 6966625 | 7114794 | 7207646 | 7077496 | 7284831 |
| 11/072529 | 7152938 | 7182434 | 7182430 | 11/102842 | 7032993 | 11/155513 |
| 11/155545 | 11/144813 | 7172266 | 7258430 | 7128392 | 7210866 | 11/488066 |
| 11/505933 | 11/540727 | 11/635480 | 11/707946 | 11/706303 | 11/709084 | 11/730776 |
| 11/744143 | 11/779845 | 11/782589 | 11/863256 | 11/940302 | 11/940235 | 11/066161 |
| 11/066160 | 11/066159 | 11/066158 | 7287831 | 11/875936 | 6804030 | 6807315 |
| 6771811 | 6683996 | 7271936 | 10/934490 | 6965691 | 7058219 | 7289681 |
| 7187807 | 7181063 | 11/338783 | 11/603823 | 11/650536 | 10/727181 | 10/727162 |
| 10/727163 | 10/727245 | 7121639 | 7165824 | 7152942 | 10/727157 | 7181572 |
| 7096137 | 10/727257 | 7278034 | 7188282 | 10/727159 | 10/727180 | 10/727179 |
| 10/727192 | 10/727274 | 10/727164 | 10/727161 | 10/727198 | 10/727158 | 10/754536 |
| 10/754938 | 10/727227 | 10/727160 | 10/934720 | 7171323 | 7278697 | 11/442131 |
| 11/474278 | 11/488853 | 11/488841 | 11749750 | 11749749 | 10/296522 | 6795215 |
| 7070098 | 7154638 | 6805419 | 6859289 | 6977751 | 6398332 | 6394573 |
| 6622923 | 6747760 | 6921144 | 10/884881 | 7092112 | 7192106 | 11/039866 |
| 7173739 | 6986560 | 7008033 | 11/148237 | 7222780 | 7270391 | 7150510 |
| 11/478599 | 11/499749 | 11/521388 | 11/738518 | 11/482981 | 11/743662 | 11/743661 |
| 11/743659 | 11/743655 | 11/743657 | 11/752900 | 11926109 | 11929567 | 7195328 |
| 7182422 | 11/650537 | 11/712540 | 10/854521 | 10/854522 | 10/854488 | 7281330 |
| 10/854503 | 10/854504 | 10/854509 | 7188928 | 7093989 | 10/854497 | 10/854495 |
| 10/854498 | 10/854511 | 10/854512 | 10/854525 | 10/854526 | 10/854516 | 7252353 |
| 10/854515 | 7267417 | 10/854505 | 10/854493 | 7275805 | 10/854489 | 10/854490 |
| 7281777 | 7290852 | 10/854528 | 10/854523 | 10/854527 | 10/854524 | 10/854520 |
| 10/854514 | 10/854519 | 10/854513 | 10/854499 | 10/854501 | 7266661 | 7243193 |
| 10/854518 | 10/854517 | 10/934628 | 7163345 | 11/499803 | 11/601757 | 11/706295 |
| 11/735881 | 11748483 | 11749123 | 11/766061 | 11775135 | 11772235 | 11/778569 |
| 11/829942 | 11/870342 | 11/935274 | 11/937239 | 11/014731 | D529081 | D541848 |
| D528597 | 6924907 | 6712452 | 6416160 | 6238043 | 6958826 | 6812972 |
| 6553459 | 6967741 | 6956669 | 6903766 | 6804026 | 7259889 | 6975429 |
| 10/636234 | 10/636233 | 7301567 | 10/636216 | 7274485 | 7139084 | 7173735 |
| 7068394 | 7286182 | 7086644 | 7250977 | 7146281 | 7023567 | 7136183 |
| 7083254 | 6796651 | 7061643 | 7057758 | 6894810 | 6995871 | 7085010 |
| 7092126 | 7123382 | 7061650 | 10/853143 | 6986573 | 6974212 | 10/943907 |
| 7173737 | 10/954168 | 7246868 | 11/065357 | 7137699 | 11/107798 | 7148994 |
| 7077497 | 11/176372 | 7248376 | 11/225158 | 11/225154 | 7173729 | 11/442132 |
| 11/478607 | 11/503085 | 11/545502 | 11/583943 | 11/585946 | 11/653239 | 11/653238 |
| 11/764781 | 11/764782 | 11/779884 | 11845666 | 11/872637 | 11/944401 | 11/940215 |
| 11/544764 | 11/544765 | 11/544772 | 11/544773 | 11/544774 | 11/544775 | 11/544776 |
| 11/544766 | 11/544767 | 11/544771 | 11/544770 | 11/544769 | 11/544777 | 11/544768 |
| 11/544763 | 11/293804 | 11/293840 | 11/293803 | 11/293833 | 11/293834 | 11/293835 |
| 11/293836 | 11/293837 | 11/293792 | 11/293794 | 11/293839 | 11/293826 | 11/293829 |
| 11/293830 | 11/293827 | 11/293828 | 7270494 | 11/293823 | 11/293824 | 11/293831 |
| 11/293815 | 11/293819 | 11/293818 | 11/293817 | 11/293816 | 11/838875 | 11/482978 |
| 11/640356 | 11/640357 | 11/640358 | 11/640359 | 11/640360 | 11/640355 | 11/679786 |
| 11/872714 | 10/760254 | 10/760210 | 10/760202 | 7201468 | 10/760198 | 10/760249 |
| 7234802 | 10/760196 | 7287846 | 7156511 | 10/760264 | 7258432 | 7097291 |
| 10/760222 | 10/760248 | 7083273 | 10/760192 | 10/760203 | 10/760204 | 10/760205 |
| 10/760206 | 10/760267 | 10/760270 | 7198352 | 10/760271 | 10/760275 | 7201470 |
| 7121655 | 7293861 | 7232208 | 10/760186 | 10/760261 | 7083272 | 7261400 |
| 11/474272 | 11/474315 | 11/501771 | 11/583874 | 11/650554 | 11/706322 | 11/706968 |
| 11/749119 | 11749157 | 11779848 | 11/782590 | 11/855152 | 11855151 | 11/870327 |
| 11/934780 | 11/935992 | 11/014764 | 11/014763 | 11/014748 | 11/014747 | 11/014761 |
| 11/014760 | 11/014757 | 11/014714 | 7249822 | 11/014762 | 11/014724 | 11/014723 |
| 11/014756 | 11/014736 | 11/014759 | 11/014758 | 11/014725 | 11/014739 | 11/014738 |
| 11/014737 | 11/014726 | 11/014745 | 11/014712 | 7270405 | 11/014751 | 11/014735 |
| 11/014734 | 11/014719 | 11/014750 | 11/014749 | 7249833 | 11/758640 | 11/775143 |
| 11/838877 | RRB038US | 11/944633 | 11/014769 | 11/014729 | 11/014743 | 11/014733 |
| 11/014754 | 11/014755 | 11/014765 | 11/014766 | 11/014740 | 7284816 | 7284845 |
| 7255430 | 11/014744 | 11/014741 | 11/014768 | 11/014767 | 11/014718 | 11/014717 |
| 11/014716 | 11/014732 | 11/014742 | 11/097268 | 11/097185 | 11/097184 | 11/778567 |
| 11852958 | 11852907 | 11/872038 | 11/293820 | 11/293813 | 11/293822 | 11/293812 |
| 11/293821 | 11/293814 | 11/293793 | 11/293842 | 11/293811 | 11/293807 | 11/293806 |
| 11/293805 | 11/293810 | 11/688863 | 11/688864 | 11/688865 | 11/688866 | 11/688867 |
| 11/688868 | 11/688869 | 11/688871 | 11/688872 | 11/688873 | 11/741766 | 11/482982 |
| 11/482983 | 11/482984 | 11/495818 | 11/495819 | 11/677049 | 11/677050 | 11/677051 |
| 11872719 | 11872718 | 11/014722 | 11/934781 | D528156 | 10/760180 | 7111935 |
| 10/760213 | 10/760219 | 10/760237 | 7261482 | 10/760220 | 7002664 | 10/760252 |
| 10/760265 | 7088420 | 11/446233 | 11/503083 | 11/503081 | 11/516487 | 11/599312 |
| 6364451 | 6533390 | 6454378 | 7224478 | 6559969 | 6896362 | 7057760 |
| 6982799 | 11/202107 | 11/743672 | 11744126 | 11/743673 | 7093494 | 7143652 |
| 7089797 | 7159467 | 7234357 | 7124643 | 7121145 | 7089790 | 7194901 |
| 6968744 | 7089798 | 7240560 | 7137302 | 11/442177 | 7171855 | 7260995 |
| 7260993 | 7165460 | 7222538 | 7258019 | 11/543047 | 7258020 | 11/604324 |
| 11/642520 | 11/706305 | 11/707056 | 11744211 | 11/767526 | 11/779846 | 11/764227 |
| 11/829943 | 11/829944 | 6454482 | 6808330 | 6527365 | 6474773 | 6550997 |
| 7093923 | 6957923 | 7131724 | 10/949288 | 7168867 | 7125098 | 11/706966 |
| 11/185722 | 7249901 | 7188930 | 11/014728 | 11/014727 | D536031 | D531214 |
| 7237888 | 7168654 | 7201272 | 6991098 | 7217051 | 6944970 | 10/760215 |
| 7108434 | 10/760257 | 7210407 | 7186042 | 10/760266 | 6920704 | 7217049 |
| 10/760214 | 10/760260 | 7147102 | 7287828 | 7249838 | 10/760241 | 10/962413 |
| 10/962427 | 7261477 | 7225739 | 10/962402 | 10/962425 | 10/962428 | 7191978 |
| 10/962426 | 10/962409 | 10/962417 | 10/962403 | 7163287 | 7258415 | 10/962523 |
| 7258424 | 10/962410 | 7195412 | 7207670 | 7270401 | 7220072 | 11/474267 |
| 11/544547 | 11/585925 | 11/593000 | 11/706298 | 11/706296 | 11/706327 | 11/730760 |
| 11/730407 | 11/730787 | 11/735977 | 11/736527 | 11/753566 | 11/754359 | 11/778061 |
| 11/765398 | 11/778556 | 11/829937 | 11/780470 | 11/866399 | 11/223262 | 11/223018 |
| 11/223114 | 11/223022 | 11/223021 | 11/223020 | 11/223019 | 11/014730 | D541849 |
| 29/279123 | 6716666 | 6949217 | 6750083 | 7014451 | 6777259 | 6923524 |
| 6557978 | 6991207 | 6766998 | 6967354 | 6759723 | 6870259 | 10/853270 |
| 6925875 | 10/898214 | 7095109 | 7145696 | 10/976081 | 7193482 | 7134739 |
| 7222939 | 7164501 | 7118186 | 7201523 | 7226159 | 7249839 | 7108343 |
| 7154626 | 7079292 | 10/980184 | 7233421 | 7063408 | 10/983082 | 10/982804 |
| 7032996 | 10/982834 | 10/982833 | 10/982817 | 7217046 | 6948870 | 7195336 |
| 7070257 | 10/986813 | 10/986785 | 7093922 | 6988789 | 10/986788 | 7246871 |
| 10/992748 | 10/992747 | 7187468 | 10/992828 | 7196814 | 10/992754 | 7268911 |
| 7265869 | 7128384 | 7164505 | 7284805 | 7025434 | 7298519 | 7280244 |
| 7206098 | 7265877 | 7193743 | 7168777 | 11/006734 | 7195329 | 7198346 |
| 7281786 | 11/013363 | 11/013881 | 6959983 | 7128386 | 7097104 | 11/013636 |
| 7083261 | 7070258 | 7083275 | 7110139 | 6994419 | 6935725 | 11/026046 |
| 7178892 | 7219429 | 6988784 | 11/026135 | 7289156 | 11/064005 | 7284976 |
| 7178903 | 7273274 | 7083256 | 11/064008 | 7278707 | 11/064013 | 6974206 |
| 11/064004 | 7066588 | 7222940 | 11/075918 | 7018025 | 7221867 | 7290863 |
| 7188938 | 7021742 | 7083262 | 7192119 | 11/083021 | 7036912 | 7175256 |
| 7182441 | 7083258 | 7114796 | 7147302 | 11/084757 | 7219982 | 7118195 |
| 7229153 | 6991318 | 7108346 | 11/248429 | 11/239031 | 7178899 | 7066579 |
| 11/281419 | 11/298633 | 11/329188 | 11/329140 | 7270397 | 7258425 | 7237874 |
| 7152961 | 11/478592 | 7207658 | 11/484744 | 11/488867 | 7207659 | 11/525857 |
| 11/540569 | 11/583869 | 11/592985 | 11/585947 | 11/601762 | 11/604316 | 11/604309 |
| 11/604303 | 11/643844 | 11/650553 | 11/655940 | 11/653320 | 7278713 | 11/706381 |
| 11/706323 | 11/706963 | 11/713660 | 7290853 | 11/696186 | 11/730390 | 11/737139 |
| 11/737749 | 11/740273 | 11749122 | 11/754361 | 11766043 | 11/764775 | 11/768872 |
| 11/775156 | 11/779271 | 11/779272 | 11/829938 | 11/839502 | 11858852 | 11/862188 |
| 019863/0806 | 11/872618 | 11/923651 | 11930001 | 6485123 | 6425657 | 6488358 |
| 7021746 | 6712986 | 6981757 | 6505912 | 6439694 | 6364461 | 6378990 |
| 6425658 | 6488361 | 6814429 | 6471336 | 6457813 | 6540331 | 6454396 |
| 6464325 | 6443559 | 6435664 | 6412914 | 6488360 | 6550896 | 6439695 |
| 6447100 | 09/900160 | 6488359 | 6637873 | 10/485738 | 6618117 | 10/485737 |
| 6803989 | 7234801 | 7044589 | 7163273 | 6416154 | 6547364 | 10/485744 |
| 6644771 | 7152939 | 6565181 | 10/485805 | 6857719 | 7255414 | 6702417 |
| 7284843 | 6918654 | 7070265 | 6616271 | 6652078 | 6503408 | 6607263 |
| 7111924 | 6623108 | 6698867 | 6488362 | 6625874 | 6921153 | 7198356 |
| 6536874 | 6425651 | 6435667 | 10/509997 | 6527374 | 10/510154 | 6582059 |
| 10/510152 | 6513908 | 7246883 | 6540332 | 6547368 | 7070256 | 6508546 |
| 10/510151 | 6679584 | 10/510000 | 6857724 | 10/509998 | 6652052 | 10/509999 |
| 6672706 | 10/510096 | 6688719 | 6712924 | 6588886 | 7077508 | 7207654 |
| 6935724 | 6927786 | 6988787 | 6899415 | 6672708 | 6644767 | 6874866 |
| 6830316 | 6994420 | 6954254 | 7086720 | 7240992 | 7267424 | 7128397 |
| 7084951 | 7156496 | 7066578 | 7101023 | 11/165027 | 11/202235 | 11/225157 |
| 7159965 | 7255424 | 11/349519 | 7137686 | 7201472 | 7287829 | 11/504602 |
| 7216957 | 11/520572 | 11/583858 | 11/583895 | 11/585976 | 11/635488 | 7278712 |
| 11/706952 | 11/706307 | 7287827 | 11944451 | 11/740287 | 11/754367 | 11/758643 |
| 11/778572 | 11859791 | 11/863260 | 11/874178 | 11/936064 | 6916082 | 6786570 |
| 10/753478 | 6848780 | 6966633 | 7179395 | 6969153 | 6979075 | 7132056 |
| 6832828 | 6860590 | 6905620 | 6786574 | 6824252 | 7097282 | 6997545 |
| 6971734 | 6918652 | 6978990 | 6863105 | 10/780624 | 7194629 | 10/791792 |
| 6890059 | 6988785 | 6830315 | 7246881 | 7125102 | 7028474 | 7066575 |
| 6986202 | 7044584 | 7210762 | 7032992 | 7140720 | 7207656 | 7285170 |
| 11/048748 | 7008041 | 7011390 | 7048868 | 7014785 | 7131717 | 7284826 |
| 11/176158 | 7182436 | 7104631 | 7240993 | 7290859 | 11/202217 | 7172265 |
| 7284837 | 7066573 | 11/298635 | 7152949 | 11/442161 | 11/442133 | 11/442126 |
| 7156492 | 11/478588 | 11/505848 | 7287834 | 11/525861 | 11/583939 | 11/545504 |
| 7284326 | 11/635485 | 11/730391 | 11/730788 | 11/749148 | 11/749149 | 11/749152 |
| 11/749151 | 11/759886 | 11/865668 | 11/874168 | 11/874203 | 6824257 | 7270475 |
| 6971811 | 6878564 | 6921145 | 6890052 | 7021747 | 6929345 | 6811242 |
| 6916087 | 6905195 | 6899416 | 6883906 | 6955428 | 7284834 | 6932459 |
| 6962410 | 7033008 | 6962409 | 7013641 | 7204580 | 7032997 | 6998278 |
| 7004563 | 6910755 | 6969142 | 6938994 | 7188935 | 10/959049 | 7134740 |
| 6997537 | 7004567 | 6916091 | 7077588 | 6918707 | 6923583 | 6953295 |
| 6921221 | 7001008 | 7168167 | 7210759 | 11/008115 | 11/011120 | 11/012329 |
| 6988790 | 7192120 | 7168789 | 7004577 | 7052120 | 11/123007 | 6994426 |
| 7258418 | 7014298 | 11/124348 | 11/177394 | 7152955 | 7097292 | 7207657 |
| 7152944 | 7147303 | 11/209712 | 7134608 | 7264333 | 7093921 | 7077590 |
| 7147297 | 11/239029 | 11/248832 | 11/248428 | 11/248434 | 7077507 | 7172672 |
| 7175776 | 7086717 | 7101020 | 11/329155 | 7201466 | 11/330057 | 7152967 |
| 7182431 | 7210666 | 7252367 | 7287837 | 11/485255 | 11/525860 | 6945630 |
| 7018294 | 6910014 | 6659447 | 6648321 | 7082980 | 6672584 | 7073551 |
| 6830395 | 7289727 | 7001011 | 6880922 | 6886915 | 6644787 | 6641255 |
| 7066580 | 6652082 | 7284833 | 6666544 | 6666543 | 6669332 | 6984023 |
| 6733104 | 6644793 | 6723575 | 6953235 | 6663225 | 7076872 | 7059706 |
| 7185971 | 7090335 | 6854827 | 6793974 | 10/636258 | 7222929 | 6739701 |
| 7073881 | 7155823 | 7219427 | 7008503 | 6783216 | 6883890 | 6857726 |
| 10/636274 | 6641256 | 6808253 | 6827428 | 6802587 | 6997534 | 6959982 |
| 6959981 | 6886917 | 6969473 | 6827425 | 7007859 | 6802594 | 6792754 |
| 6860107 | 6786043 | 6863378 | 7052114 | 7001007 | 10/729151 | 10/729157 |
| 6948794 | 6805435 | 6733116 | 10/683006 | 7008046 | 6880918 | 7066574 |
| 6983595 | 6923527 | 7275800 | 7163276 | 7156495 | 6976751 | 6994430 |
| 7014296 | 7059704 | 7160743 | 7175775 | 7287839 | 7097283 | 7140722 |
| 11/123009 | 11/123008 | 7080893 | 7093920 | 7270492 | 7128093 | 7052113 |
| 7055934 | 11/155627 | 7278796 | 11/159197 | 7083263 | 7145592 | 7025436 |
| 11/281444 | 7258421 | 11/478591 | 11/478735 | 7226147 | 11/482940 | 7195339 |
| 11/503061 | 11/505938 | 7284838 | 7293856 | 11/544577 | 11/540576 | 11/585964 |
| 11/592991 | 11/599342 | 11/600803 | 11/604321 | 11/604302 | 11/635535 | 11/635486 |
| 11/643842 | 11/655987 | 11/650541 | 11/706301 | 11/707039 | 11/730388 | 11/730786 |
| 11/730785 | 11/739080 | 11/764746 | 11/768875 | 11/779847 | 11/829940 | 11847240 |
| 11/834625 | 11/863210 | 11/865680 | 11/874156 | 11/923602 | 7067067 | 6776476 |
| 6880914 | 7086709 | 6783217 | 7147791 | 6929352 | 7144095 | 6820974 |
| 6918647 | 6984016 | 7192125 | 6824251 | 6834939 | 6840600 | 6786573 |
| 7144519 | 6799835 | 6959975 | 6959974 | 7021740 | 6935718 | 6938983 |
| 6938991 | 7226145 | 7140719 | 6988788 | 7022250 | 6929350 | 7011393 |
| 7004566 | 7175097 | 6948799 | 7143944 | 10/965737 | 7029100 | 6957811 |
| 7073724 | 7055933 | 7077490 | 7055940 | 10/991402 | 7234645 | 7032999 |
| 7066576 | 7229150 | 7086728 | 7246879 | 7284825 | 7140718 | 7284817 |
| 7044577 | 7284824 | 7284827 | 7189334 | 7055935 | 7152860 | 11/203188 |
| 11/203173 | 11/202343 | 7213989 | 11/225156 | 11/225173 | 11/228433 | 7114868 |
| 7168796 | 7159967 | 11/272425 | 7152805 | 11/298530 | 11/330061 | 7133799 |
| 11/330054 | 11/329284 | 7152956 | 7128399 | 7147305 | 7287702 | 11/442160 |
| 7246884 | 7152960 | 11/442125 | 11/454901 | 11/442134 | 11/450441 | 11/474274 |
| 11/499741 | 7270399 | 6857728 | 6857729 | 6857730 | 6989292 | 7126216 |
| 6977189 | 6982189 | 7173332 | 7026176 | 6979599 | 6812062 | 6886751 |
| 10/804057 | 10/804036 | 7001793 | 6866369 | 6946743 | 10/804048 | 6886918 |
| 7059720 | 10/846561 | 10/846562 | 10/846647 | 10/846649 | 10/846627 | 6951390 |
| 6981765 | 6789881 | 6802592 | 7029097 | 6799836 | 7048352 | 7182267 |
| 7025279 | 6857571 | 6817539 | 6830198 | 6992791 | 7038809 | 6980323 |
| 7148992 | 7139091 | 6947173 | 7101034 | 6969144 | 6942319 | 6827427 |
| 6984021 | 6984022 | 6869167 | 6918542 | 7007852 | 6899420 | 6918665 |
| 6997625 | 6988840 | 6984080 | 6845978 | 6848687 | 6840512 | 6863365 |
| 7204582 | 6921150 | 7128396 | 6913347 | 7008819 | 6935736 | 6991317 |
| 7284836 | 7055947 | 7093928 | 7100834 | 7270396 | 7187086 | 7290856 |
| 7032825 | 7086721 | 7159968 | 7010456 | 7147307 | 7111925 | 11/144812 |
| 7229154 | 11/505849 | 11/520570 | 11/520575 | 11/546437 | 11/540575 | 11/583937 |
| 7278711 | 7290720 | 11/592207 | 11/635489 | 11/604319 | 11/635490 | 11/635525 |
| 7287706 | 11/706366 | 11/706310 | 11/706308 | 11/785108 | 11/744214 | 11744218 |
| 11748485 | 11748490 | 11/764778 | 11/766025 | 11/834635 | 11839541 | 11860420 |
| 11/865693 | 11/863118 | 11/866307 | 11/866340 | 11/869684 | 11/869722 | 11/869694 |
| 11/876592 | 11/945244 | 11/945238 | | | | |

### BACKGROUND OF THE INVENTION

The Applicant has developed a wide range of printers that employ pagewidth printheads instead of traditional reciprocating printhead designs. Pagewidth designs increase print speeds as the printhead does not traverse back and forth across the page to deposit a line of an image. The pagewidth printhead simply deposits the ink on the media as it moves past at high speeds. Such printheads have made it possible to perform full colour 1600 dpi printing at speeds in the vicinity of 60 pages per minute; speeds previously unattainable with conventional inkjet printers.

Printing at these speeds consumes ink quickly and this gives rise to problems with supplying the printhead with enough ink. Not only are the flow rates higher but distributing the ink along the entire length of a pagewidth printhead is more complex than feeding ink to a relatively small reciprocating printhead.

Some of the Applicant's printers provide the printhead as a user removable cartridge. This recognizes that individual ink ejection nozzles may fail over time and eventually there are enough dead nozzles to cause artifacts in the printed image. Allowing the user to replace the printhead maintains the print quality without requiring the entire printer to be replaced. It also permits the user to substitute a different printhead for different print jobs. A draft quality printhead can be installed for some low resolution documents printed at high speed, and subsequently removed and replaced with the original high resolution printhead.

A number of the Applicant's printhead cartridges do not have an inbuilt ink supply for the printhead. These printhead cartridges need to be fluidically coupled to the ink supply upon installation. The supply flowrate to the pagewidth printhead is too high for needle valves because of the narrow internal diameter. This requires the coupling conduits to be relatively large and while the complementary structures on each side of the coupling may be self sealing upon disengagement, the wet surfaces can have enough residual ink to drip or run over the exterior surface of the coupling.

Cross contamination of different colored inks is very detrimental to print quality. A drip from the black ink conduit onto the yellow ink conduit can change the color balance for many pages of printing. To avoid this, the conduits should be spaced from each other and positioned such that one conduit is never likely to be vertically above another during installation or removal. However, spacing the conduits apart is counter to compact design and structurally there is less flex in the components during engagement and disengagement if the conduits are clustered around a central axis.

### SUMMARY OF THE INVENTION

Accordingly, the present invention provides a fluid coupling for an inkjet printhead, the fluid coupling comprising:

an interface plate supporting a plurality of spouts positioned for sealed engagement with corresponding apertures in a complementary socket in order to establish fluid communication between an inkjet printhead and an ink supply; wherein,

the interface plate has surface formations individually associated with each of the spouts respectively, the surface formations defining a preferred flow path along the interface plate for any residual ink draining away from the spouts under gravity, the preferred flow paths being configured to avoid any of the other spouts.

The invention recognizes that subtle surface modifications can be used to define a fluid flow path that residual drops will follow with good reliability. This permits the spouts to be clustered together with little chance of any cross contamination between the colors.

Preferably, the surface formations are grooves in the interface plate. In a further preferred form, the spouts are arranged in a circular formation on the interface plate. In a particularly preferred form, the inkjet printhead is provided as a user replaceable cartridge for installation in a printer body that has the ink supply, the interface plate being positioned on the exterior of the printhead cartridge and the socket being positioned on the printer body. In a particularly preferred form, the grooves extend in a generally vertical direction when the printhead cartridge is oriented as it would be when installed, the grooves deviating from generally vertical to avoid one of the spouts of different color.

In some embodiments, the printhead cartridge has a recess feature the grooves begin at their respective spouts and end at the recess feature. In particularly preferred embodiments, the printhead is a pagewidth printhead. In some embodiments, the printer is an A4 printer and the printhead can print at speeds greater than 40 pages per minute. In some embodiments, each of the apertures in the socket has a shut off valve that is biased closed, the shut off valve being held open when engaged with the corresponding spout. Preferably, the printhead cartridge has an inlet manifold and an outlet manifold, both the inlet and outlet manifolds having a fluid coupling according to the present invention.

### BRIEF DESCRIPTION OF THE DRAWINGS

Preferred embodiments of the invention will now be described by way of example only, with reference to the accompanying figures, in which:

FIG. 1 shows the printhead cartridge of the present invention installed the print engine of a printer;

FIG. 2 shows the print engine without the printhead cartridge installed to expose the inlet and outlet ink couplings;

FIG. 3 is a perspective of the complete printhead cartridge according to the present invention;

FIG. 4 shows the printhead cartridge of FIG. 3 with the protective cover removed;

FIG. 5 is an exploded partial perspective of the printhead assembly within the printhead cartridge of FIG. 3;

FIG. 6 is a partial front elevation of the printhead cartridge of FIG. 3; and,

FIG. 7 is a partial perspective of the printhead cartridge of FIG. 3.

### DETAILED DESCRIPTION OF THE PREFERRED EMBODIMENTS

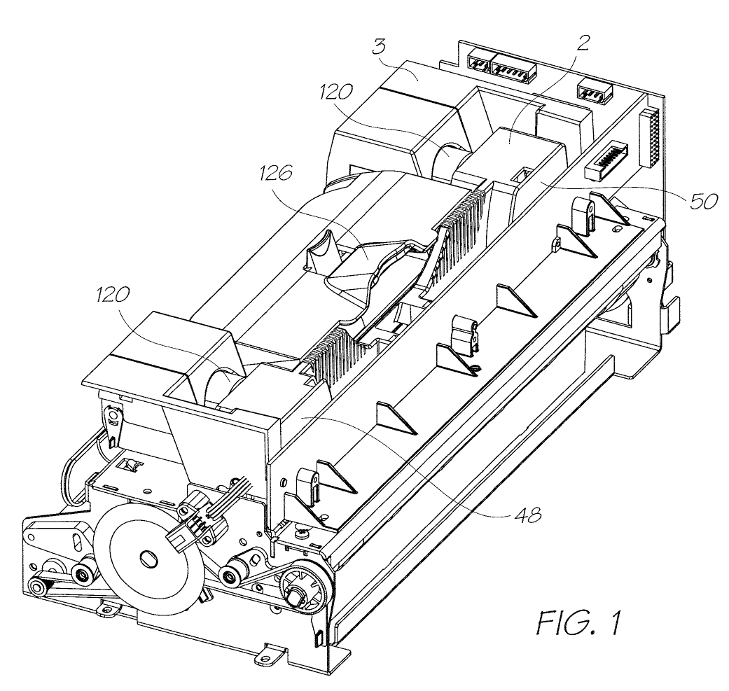

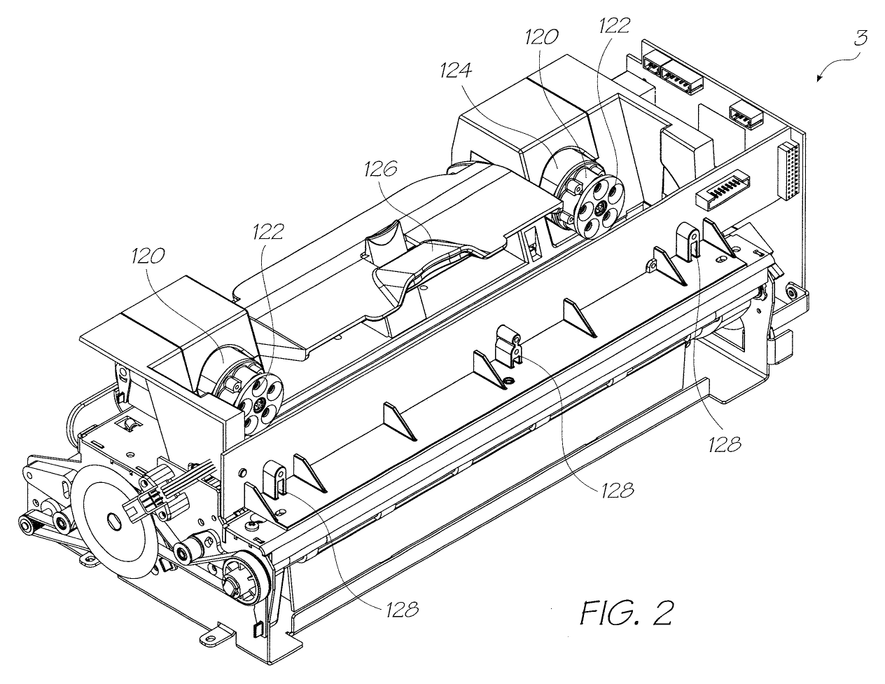

FIG. 1 shows a printhead cartridge 2 installed in a print engine 3. The print engine 3 is the mechanical heart of a printer which can have many different external casing shapes, ink tank locations and capacities, as well as media feed and collection trays. The printhead cartridge 2 is inserted and removed by the user lifting and lowering the latch 126. The print engine 3 forms an electrical connection with contacts on the printhead cartridge 2 (described below) and a fluid coupling via the sockets 120 and the inlet and outlet manifolds, 48 and 50 respectively. FIG. 2 shows the print engine 3 with the printhead cartridge removed reveal the apertures 122 in each of the sockets 120. Each aperture 122 receives one of the spouts 52 on the inlet and outlet manifolds. As discussed above, the ink tanks have an arbitrary position and configuration but simply connect to hollow spigots 124 at the rear of the sockets 120.

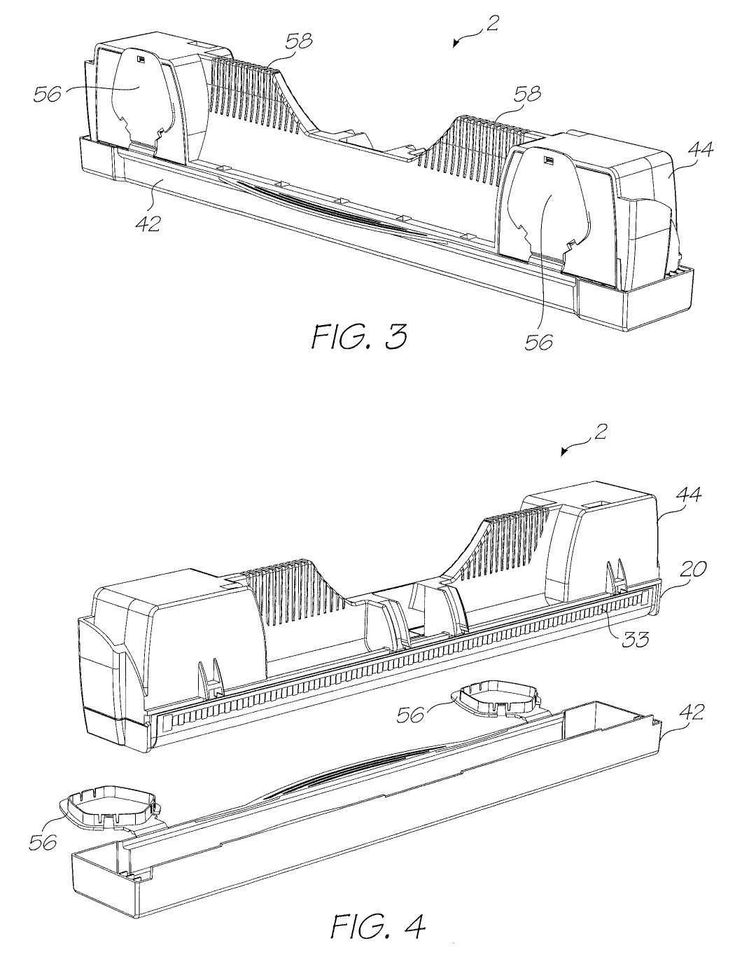

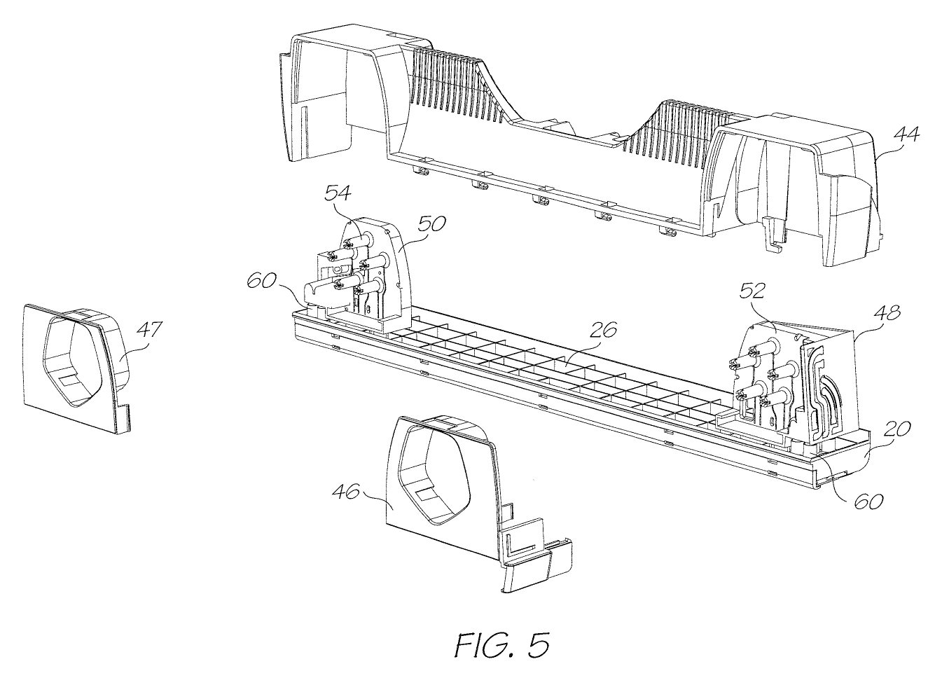

FIG. 3 is a perspective of the complete printhead cartridge 2. The printhead cartridge 2 has a top molding 44 and a removable protective cover 42. The top molding 44 has a central web for structural stiffness and to provide grip textured surfaces 58 for manipulating the cartridge during insertion and removal. The base portion of the protective cover 42 protects the printhead ICs (not shown) and line of contacts (not shown) prior to installation in the printer. Caps 56 are integrally formed with the base portion and cover the ink inlets and outlets (see 54 and 52 of FIG. 5).

FIG. 4 shows the printhead assembly 2 with its protective cover 42 removed to expose the printhead ICs on the bottom surface and the line of contacts 33 on the side surface. The protective cover is discarded to the recycling waste or fitted to the printhead cartridge being replaced to contain leakage from residual ink. FIG. 5 is a partially exploded perspective of the printhead assembly 2. The top cover 44 has been removed reveal the inlet manifold 48 and the outlet manifold 50. The inlet and outlet shrouds 46 and 47 have been removed to better expose the five inlet and outlet spouts 52. The inlet and outlet manifolds 48 and 50 form a fluid connection between each of the individual inlets and outlets and the corresponding main channel in the LCP molding. The main channel extends the length of the LCP molding and it feeds a series of fine channels on the underside of the LCP molding. A line of air cavities are formed above each of the main channels 24. Any shock waves or pressure pulses in the ink are damped by compressing the air the air cavities.

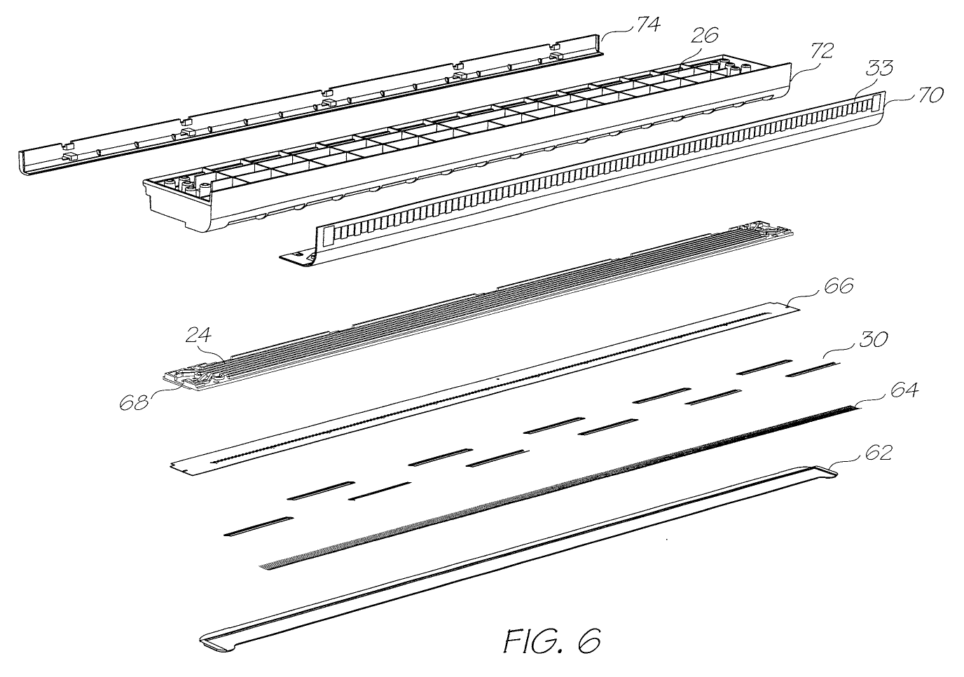

FIG. 6 is an exploded perspective of the printhead assembly without the inlet or outlet manifolds or the top cover molding. The main channels 24 for each ink color and their associated air cavities 26 are formed in the channel molding 68 and the cavity molding 72. Adhered to the bottom of the channel molding 68 is a die attach film 66. The die attach film 66 mounts the printhead ICs 31 to the channel molding such that the fine channels on the underside of the are in fluid communication with the printhead ICs 31 via small laser ablated holes through the film.

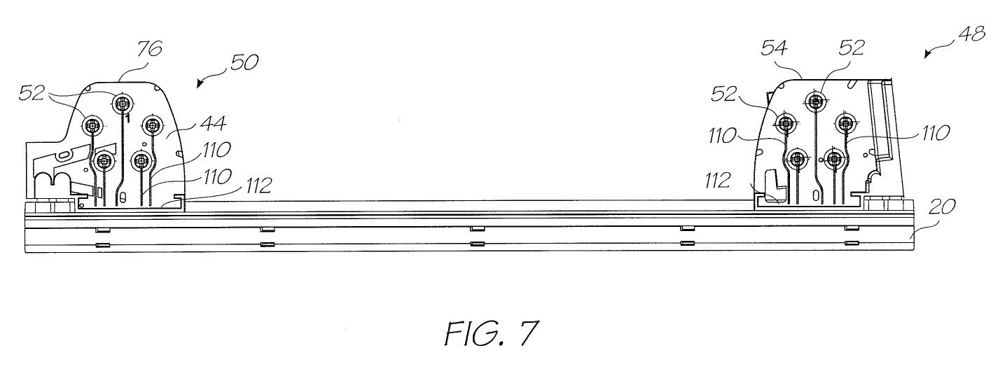

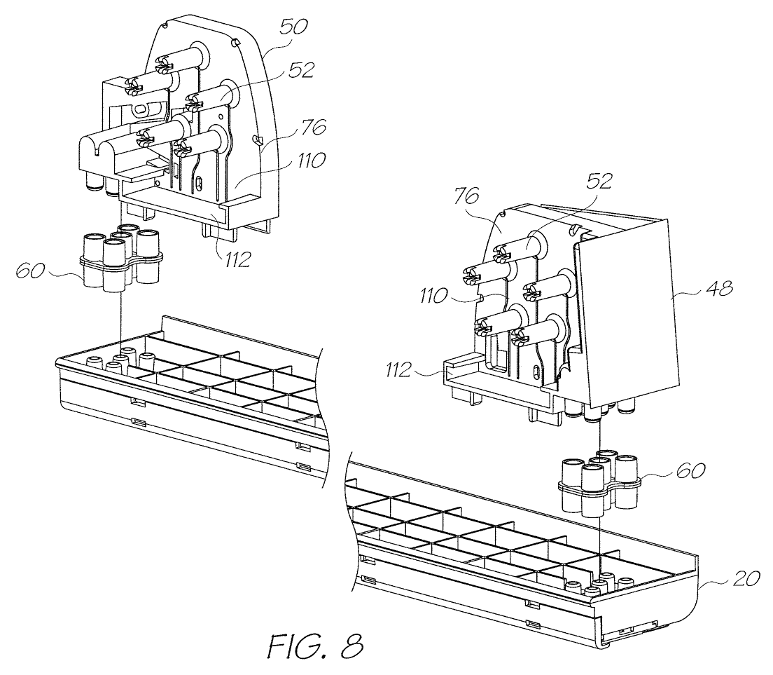

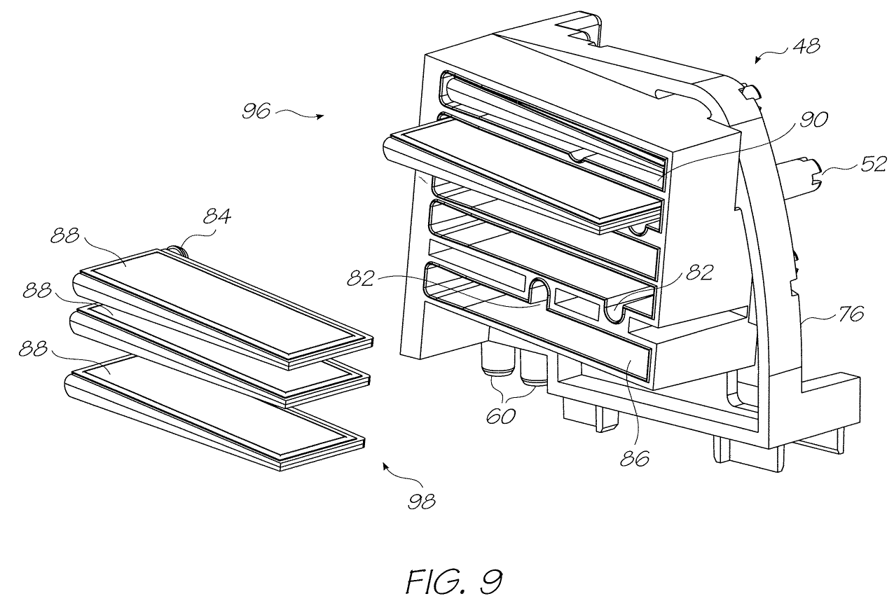

FIG. 7 shows the inlet and outlet manifolds, 48 and 50, in elevation. Both manifolds have an interface plate 76 from which the spouts 52 extend. The spouts 52 have a relatively large internal diameter (approx. 2 mm) compared to, say, a needle valve. This accommodates the high ink flow rate used by a pagewidth printhead, printing A4 sheets at speeds greater than 40 ppm (typically 60 ppm) at a resolution of 1600 dpi.

As best shown in FIG. 8, the inlet and outlet manifolds 48 and 50, form a fluid connection between spouts 52 and the LCP moldings 20 via the connectors 60. The spouts in each manifold are arranged in a circle. Keeping the spouts 52 clustered close together on the inlet and outlet manifolds is less structurally stressful on the plastic moldings of the printhead cartridge. A single force applied at the centre of the spouts 52 can engage the socket instead of distributed forces acting across widely spaced spouts, or a single force that needs to be distributed by a structure stiffened to resist bending. Referring back to FIG. 2, the print engine 3 has three structurally stiff reference datums 128. The inlet and outlet manifolds bear directly onto the outer reference datums (see FIG. 1) so that their reaction force is directed though the centre of the five spouts 52. The centre datum 128 provides a reaction force directly opposing the force of the latch 126 holding the printhead cartridge in place.

Disengaging the printhead cartridge 2 from the apertures 122 in the sockets 120 can cause residual ink to dribble from the spouts 52. As discussed above, the spouts on each manifold are clustered together. Grooves 110 are formed in the interface plates 76 to control the flow direction of any residual ink as it runs from a spout under gravity. Without any flow control measures, there is a good chance that the residual ink from one spout would flow onto the spout of a different color. The resulting color mixing is reasonably rapid and pervasive throughout the printhead cartridge 2. If the cartridge is subsequently re-installed in the print engine, the color mixing changes the color balance and is detrimental to image quality. The grooves 110 define a flow path that is generally vertically downwards to be consistent with the gravity feed of the residual drops. The grooves 110 deviate from the vertical in order to avoid other spouts. The grooves 110 terminate in a recess 112 beneath the circle of spouts 52. Residual ink collects in the recess 112 so as to avoid inadvertent spillage and ink stains.

The grooves 110 can be small relative to the size of the residual ink drops draining from the spout 52. Rather than contain the flow, the grooves can merely define a preferred flow path that the drop chooses in preference to all others. For this, the grooves need only be enough to draw and guide the drop by capillary action. The ordinary worker will appreciate that the preferential flow path may also be defined by a ridge, or a series of discrete formations spaced along the interface plate.

The above embodiments are purely illustrative and not restrictive or limiting on the scope of the invention. The skilled worker will readily recognize many variations and modifications which do not depart from the spirit and scope of the broad inventive concept.

1. A fluid coupling for an inkjet printhead, the fluid coupling comprising:
an interface plate supporting a plurality of spouts positioned for sealed engagement with corresponding apertures in a complementary socket in order to establish fluid communication between an inkjet printhead and an ink supply; wherein,
the interface plate has surface formations individually associated with each of the spouts respectively, the surface formations defining a preferred flow path along the interface plate for any residual ink draining away from the spouts under gravity, the preferred flow paths being configured to avoid any of the other spouts.

2. A fluid coupling according to claim 1 wherein the surface formations are grooves in the interface plate.

3. A fluid coupling according to claim 2 wherein the spouts are arranged in a circular formation on the interface plate.

4. A fluid coupling according to claim 3 wherein the inkjet printhead is provided as a user replaceable cartridge for installation in a printer body that has the ink supply, the interface plate being positioned on the exterior of the printhead cartridge and the socket being positioned on the printer body.

5. A fluid coupling according to claim 4 wherein the grooves extend in a generally vertical direction when the printhead cartridge is oriented as it would be when installed, the grooves deviating from generally vertical to avoid one of the spouts of different color.

6. A fluid coupling according to claim 5 wherein the printhead cartridge has a recess feature and the grooves begin at their respective spouts and end at the recess feature.

7. A fluid coupling according to claim 1 wherein the printhead is a pagewidth printhead.

8. A fluid coupling according to claim 7 wherein the printer is an A4 printer and the printhead can print at speeds greater than 40 pages per minute.

9. A fluid coupling according to claim 8 wherein each of the apertures in the socket has a shut off valve that is biased closed, the shut off valve being held open when engaged with the corresponding spout.

10. A fluid coupling according to claim 1 wherein the printhead cartridge has an inlet manifold and an outlet manifold, both the inlet and outlet manifolds having a fluid coupling according to the present invention.
